(19) United States
(12) Patent Application Publication
(10) Pub. No.: US 2010/0228902 A1
(43) Pub. Date: Sep. 9, 2010

(54) KVM SWITCH APPARATUS WITH BRIDGING FUNCTION

(76) Inventors: Cheng-Sheng CHOU, Banciao City (TW); Hung-June WU, Banciao City (TW)

Correspondence Address: HDLS Patent & Trademark Services, P.O. BOX 220746, CHANTILLY, VA, 20153-0746, US

(21) Appl. No.: 12/396,650

(22) Filed: Mar. 3, 2009

(51) Int. Cl. G06F 13/00; G06F 13/36

(52) U.S. Cl. 710/306; 710/316

(57) ABSTRACT

A KVM switch apparatus with bridging function includes a processor with a keyboard connection interface and a mouse connection interface; a keyboard/mouse switching circuit; a USB bridge unit and at least one computer interface unit electrically connected to at least one computer. The keyboard/mouse switching circuit and the USB bridge unit are selectively connected, whereby a switching of bridging channels is provided between at least two computers.

### BACKGROUND OF THE INVENTION

1. Field of the Invention

The present invention relates a KVM (keyboard-video-mouse) switch apparatus with bridging function and enabling mouse cursor to move cross multiple monitors, especially to a KVM switch apparatus providing switching of bridging channels between any two computers and enabling mouse cursor to move cross multiple monitors.

2. Description of Prior Art

In the current KVM (keyboard-video-mouse) switch apparatus, each connection port is independent. Moreover, communication and resource-sharing channel (namely point to point connection) cannot be set up for various computers through the KVM switch apparatus. For data transmission application or other application requiring communication, external storage and additional interface are required. It is both increasing cost and troublesome for user.

Therefore, it is desirable to provide a KVM switch apparatus with bridging function and enabling mouse cursor to move cross multiple monitors to overcome above-mentioned drawbacks.

### SUMMARY OF THE INVENTION

It is an object of the present invention to provide a KVM switch apparatus with bridging function, which provides switching of bridging channels between any two computers. Therefore, any two computers can establish point-to-point connection for resource sharing.

It is another object of the present invention to provide a KVM switch apparatus enabling mouse cursor to move cross multiple monitors.

Accordingly, the present invention provides a KVM switch apparatus with bridging function, which comprises a processor comprising a keyboard connection interface and a mouse connection interface; a keyboard/mouse switching circuit; a USB bridge unit and at least one computer interface unit electrically connected to at least one computer. The keyboard/mouse switching circuit and the USB bridge unit are selectively connected, whereby a switching of bridging channels is provided between at least two computers.

Accordingly, the present invention provides a KVM switch apparatus enabling mouse cursor to move cross multiple monitors, the KVM switch apparatus comprising a processor, a keyboard/mouse switching circuit, and computer interface units, the processor having a keyboard connection interface and a mouse connection interface and installed with a system driver, each of the computer interface units electrically connected to one corresponding computer, each computer having a monitor, the keyboard connection interface and the mouse connection interface electrically connected to a mouse and a keyboard, the KVM switch apparatus characterized in that:

when a mouse cursor is moved to a rightmost edge of a first monitor of a first computer connected to a first computer interface unit, the system driver sends an absolute address of the mouse cursor and an indication that the mouse cursor reaches the rightmost edge to the processor; and the processor controlling the keyboard/mouse switching circuit to connect to a second computer interface unit, and placing the mouse cursor to the leftmost edge of a second monitor of a second computer connected to the second computer interface unit, where the second monitor is on the right side of the first monitor. The mouse cursor can be

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows the block diagram of the KVM switch apparatus with bridging function according to the present invention.

FIG. 2 depicts a switch selection of computer port.

FIG. 3 is a detailed block diagram for KVM switch apparatus with bridging function according to the present invention.

FIG. 4 shows the computer interface unit according to another embodiment of the present invention.

FIG. 5 shows still another embodiment of the present invention.

FIG. 6 demonstrates the automatic switching the mouse cursor when the mouse cursor is moving cross multiple monitors in rightward direction.

FIG. 7 demonstrates the automatic switching the mouse cursor when the mouse cursor is moving cross multiple monitors in leftward direction.

### DETAILED DESCRIPTION OF THE INVENTION

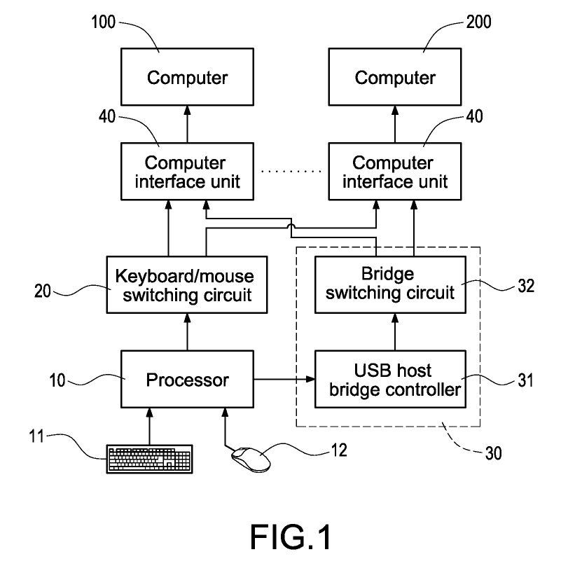

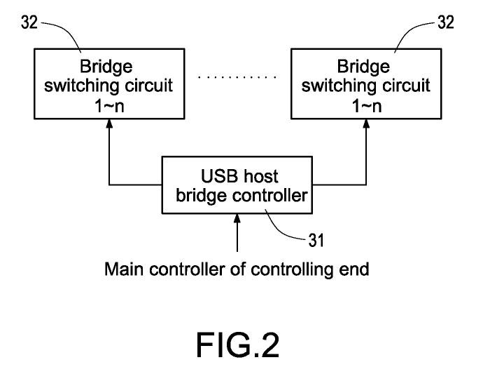

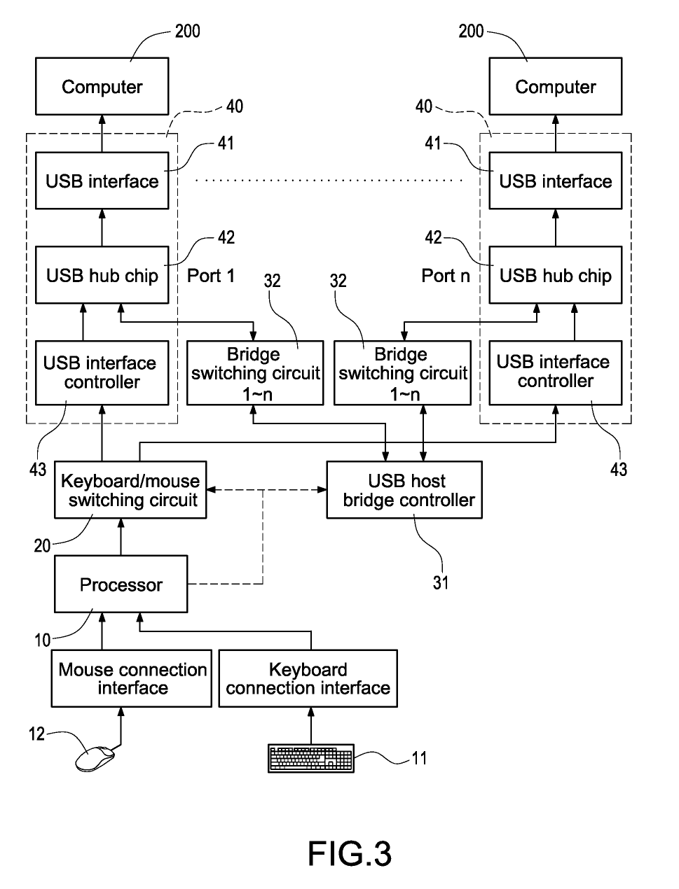

With reference to FIGS. 1 to 3, where FIG. 1 shows the block diagram of the KVM switch apparatus with bridging function according to the present invention; FIG. 2 depicts a switch selection of computer port; and FIG. 3 is a detailed block diagram for KVM switch apparatus with bridging function according to the present invention.

The KVM (keyboard-video-mouse) switch apparatus with bridging function and enabling mouse cursor to move cross multiple monitors mainly comprises a processor 10, a keyboard/mouse switching circuit 20, a USB bridge unit 30 and at least one computer interface unit 40.

The processor 10 comprises a keyboard connection interface (not shown) and a mouse connection interface (not shown), where the keyboard connection interface and the mouse connection interface are for example but not limited to, USB interface or PS/2 interface. Through the keyboard connection interface and the mouse connection interface, the processor 10 is respectively connected to a keyboard 11 and a mouse 12. The keyboard 11 and the mouse 12 are well-known art and the detailed description thereof is omitted here.

The keyboard/mouse switching circuit 20 is electrically connected to the processor 10 and comprises a plurality of first switching units 1˜n for switching a connection to the keyboard 11 and the mouse 12. Moreover, the number of the first switching units 1˜n of the keyboard/mouse switching circuit 20 can be changed according to practical need.

The USB bridge unit 30 is electrically connected to the processor 10, and comprises a USB host bridge controller 31 and a bridge switching circuit 32. The USB host bridge controller 31 is electrically connected to the processor 10 and deals with the communication between two bridged computers 100 and 200, whereby the computer 100 can control the computer 200 and vice versa. The example in FIG. 1 is demonstrated by two computers 100 and 200 and this is not limitation for the scope of the present invention. The bridge switching circuit 32 is electrically connected to the USB host bridge controller 31 and the computer interface units 40 of the computers 100 (200), whereby the bridge switching circuit 32 can provide channel switching for the computers 100 and 200.

The bridge switching circuit 32 further comprises a plurality of second switching units 1˜n therein to provide channel selection for the computers 100 and 200. The number of the second switching units 1˜n, for example, can be the same as that of the first switching units in the keyboard/mouse switching circuit 20. However, it is not the limitation for the number of the second switching units, which can be adjusted according to practical need.

The computer interface 40 is electrically connected to the processor 10 and the USB bridge unit 30 and used for linking to at least one of computers 100 and 200. The computer interface unit 40 further comprises a USB interface 41, a USB hub chip 42, and a USB interface controller 43. The USB interface 41 is electrically connected to the computer 100 or the computer 200. The USB hub chip 42 is electrically connected to the USB interface 41 for providing USB signal regeneration. The USB interface controller 43 is electrically connected to the USB hub chip 42 and further electrically connected to the keyboard/mouse switching circuit 20 and the bridge switching circuit 32, respectively, to provide USB interface signal processing function.

The KVM switch apparatus with bridging function according to the present invention further comprises a printed circuit board (not shown) and a casing (not shown). The printed circuit board is used to mount the processor 10, the keyboard/mouse switching circuit 20, the USB bridge unit 30 and the computer interface unit 40 and so on. The casing is used to enclose and protect all elements mounted on the printed circuit board. The printed circuit board and the casing are well know art for KVM switch, and the detailed description is omitted here for clarity.

As shown in FIGS. 2 and 3, in the KVM switch apparatus according to the present invention, the keyboard/mouse switching circuit 20 and the bridge switching circuit 32 are selectively connected, whereby the USB host bridge controller 31 provides selection of bridging channels between the two computers 100 and 200. Therefore, data transmission and resource sharing can be provided between any two computers 100 and 200. In this regard, the KVM switch apparatus according to the present invention is much advanced than prior art KVM switch apparatus.

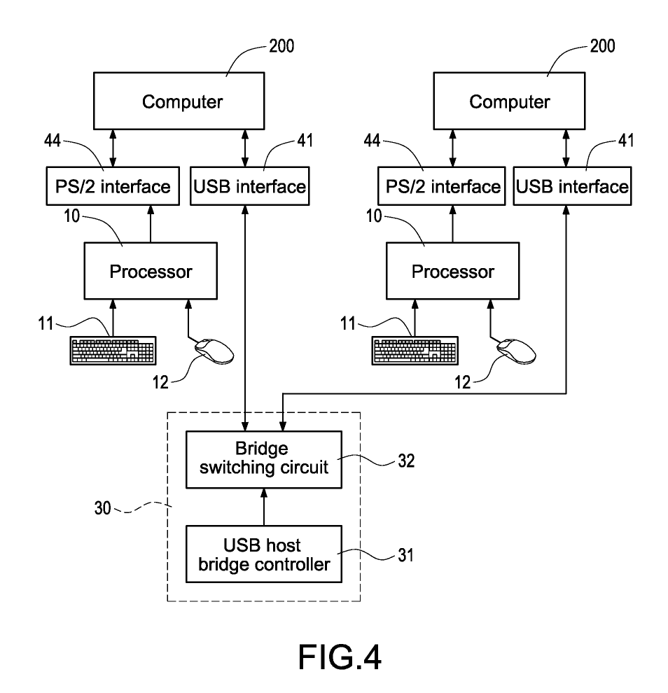

FIG. 4 shows another embodiment of the present invention, where the computer interface unit 40 further comprises a PS/2 interface 44. As shown in this figure, the PS/2 interface 44 provides connection for a PS/2 keyboard 11 or a PS/2 mouse 12. The remaining portions in this figure have similar operation as previous example, and the description is omitted here for clarity.

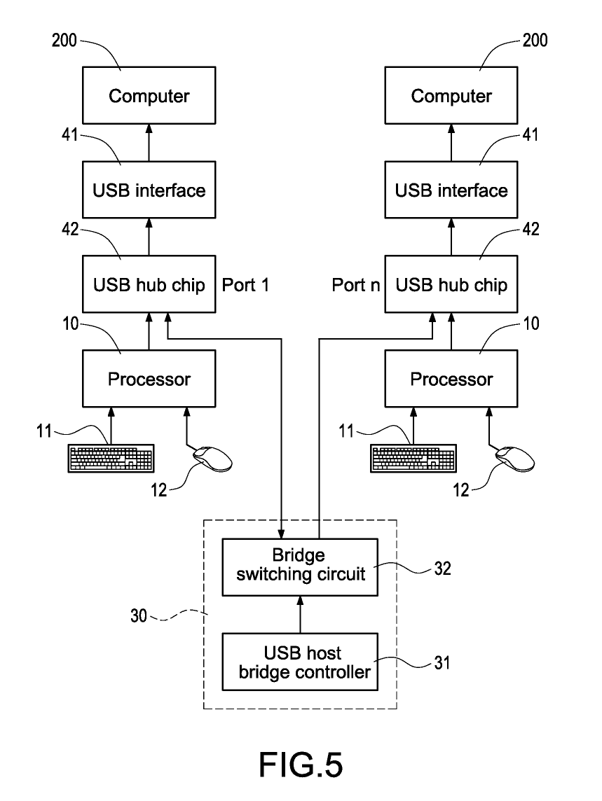

FIG. 5 shows still another embodiment of the present invention, where the KVM switch apparatus according to the present invention further comprises a circuit (not shown) for PS/2 to USB interface conversion. Therefore, the signal from an external PS/2 keyboard 11 or PS/2 mouse 12 is converted to USB signal and then sent to the USB interface controller 43 for further processing.

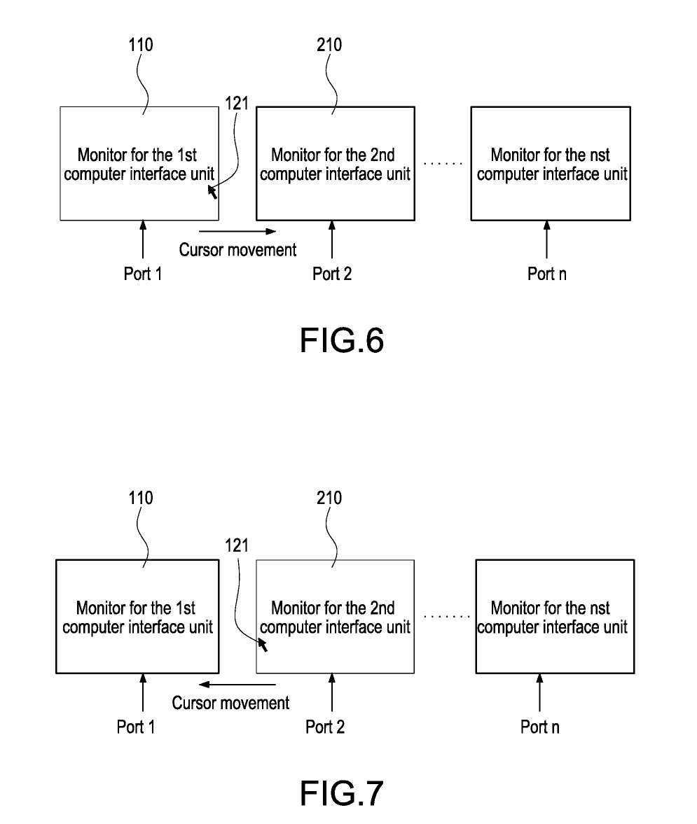

Moreover, the present invention also provides a KVM switch apparatus enabling mouse cursor to move cross multiple monitors. Please refer to FIGS. 1 and 6, where FIG. 6 demonstrates the automatic switching the mouse cursor when the mouse cursor is moving cross multiple monitors in rightward direction. The KVM switch apparatus enabling mouse cursor to move cross multiple monitors comprises the processor 10, the keyboard/mouse switching circuit 20 and the computer interface units 40 as shown in FIG. 1. The processor 10 further comprises a keyboard connection interface (not shown) and a mouse connection interface (not shown).

The processor 10 is installed with a system driver (not shown) and each of the computer interface units 40 is electrically connected to one corresponding computer 100, where each computer 100 has a monitor 110. The keyboard connection interface and the mouse connection interface are electrically connected to a keyboard 11 and a mouse 12, respectively. The KVM switch apparatus enabling mouse cursor to move cross multiple monitors is characterized in followings. When the mouse cursor 121 is moved to the rightmost edge of the monitor 110 of the computer 100 connected to the computer interface unit 40, the system driver sends an absolute address of the mouse cursor 121 and an indication that the mouse cursor 121 reaches the rightmost edge to the processor 100. Afterward, the processor 10 controls the keyboard/mouse switching circuit 20 to the second computer interface unit 40, and the mouse cursor 121 is placed to the leftmost edge of the monitor 210 of the computer 200 connected to the second computer interface unit 40, where the monitor 210 is on the right side of the monitor 110. Therefore, user can directly control the computer 100 and 200 by the keyboard 11 and the mouse 12 with the computer interface units 40.

The keyboard connection interface (not shown) and a mouse connection interface (not shown) are, for example but not limited to, USB interface or PS/2 interface. Moreover, the processor 10 further comprises circuit (not shown) for PS/2 to USB interface conversion and the detailed description can be referred to preceding paragraphs.

Please refer to FIGS. 1 and 7, where FIG. 7 demonstrates the automatic switching the mouse cursor when the mouse cursor is moving cross multiple monitors in leftward direction.

The KVM switch apparatus enabling mouse cursor to move cross multiple monitors is characterized in followings. When the mouse cursor 121 is moved to the leftmost edge of the monitor 210 of the computer 200 connected to the second computer interface unit 40, the system driver sends an absolute address of the mouse cursor 121 and an indication that the mouse cursor 121 reaches the leftmost edge to the processor 100. Afterward, the processor 10 controls the keyboard/mouse switching circuit 20 to the first computer interface unit 40, and the mouse cursor 121 is placed to the rightmost edge of the monitor 110 of the computer 100 connected to the first computer interface unit 40, where the monitor 110 is on the left side of the monitor 210. Therefore, user can directly control the computer 100 and 200 by the keyboard 11 and the mouse 12 with the computer interface units 40.

Accordingly, the KVM switch apparatus with bridging function according to the present invention can provide switching of bridging channels between any two computers. Therefore, any two computers can establish point-to-point connection for resource sharing. Moreover, the KVM switch apparatus according to the present invention enables mouse cursor to move cross multiple monitors.

What is claimed is:

1. A KVM switch apparatus with bridging function comprises:
a processor comprising a keyboard connection interface and a mouse connection interface for connecting to a keyboard and a mouse respectively;
a keyboard/mouse switching circuit electrically connected to the processor;
a USB bridge unit electrically connected to the processor;
at least one computer interface unit electrically connected to the processor and the USB bridge unit, the at least one computer interface unit also connected to at least one computer;
wherein the keyboard/mouse switching circuit and the USB bridge unit are selectively connected, whereby a switching of bridging channels is provided between at least two computers.

2. The KVM switch apparatus in claim 1, wherein the keyboard connection interface and the mouse connection interface are USB interfaces or PS/2 interfaces.

3. The KVM switch apparatus in claim 1, wherein the USB bridge unit further comprises:
a host bridge controller electrically connected to the processor and dealing with the communication between two bridged computers;
a bridge switching circuit electrically connected to the host bridge controller and the at least one computer interface unit to provide switching of channel for two computers.

4. The KVM switch apparatus in claim 3, wherein each of the computer interface units comprises:
a USB interface electrically connected to the computer;
a USB hub chip electrically connected to the USB interface for providing USB signal regeneration; and
a USB interface controller electrically connected to the USB hub chip, the keyboard/mouse switching circuit and the bridge switching circuit, respectively.

5. The KVM switch apparatus in claim 4, wherein each of the computer interface units further comprises:
a PS/2 interface for connecting to a PS/2 mouse or PS/2 keyboard.

6. The KVM switch apparatus in claim 5, wherein the processor comprises circuit for PS/2 to USB interface conversion.

7. The KVM switch apparatus in claim 1, further comprising a printed circuit board to mount the processor, the keyboard/mouse switching circuit, the USB bridge unit and the computer interface unit.

8. A KVM switch apparatus enabling mouse cursor to move cross multiple monitors, the KVM switch apparatus comprising a processor, a keyboard/mouse switching circuit, and computer interface units, the processor having a keyboard connection interface and a mouse connection interface and installed with a system driver, each of the computer interface units electrically connected to one corresponding computer, each computer having a monitor, the keyboard connection interface and the mouse connection interface electrically connected to a mouse and a keyboard, the KVM switch apparatus characterized in that:
when a mouse cursor is moved to a rightmost edge of a first monitor of a first computer connected to a first computer interface unit, the system driver sends an absolute address of the mouse cursor and an indication that the mouse cursor reaches the rightmost edge to the processor;
the processor controlling the keyboard/mouse switching circuit to connect to a second computer interface unit, and placing the mouse cursor to the leftmost edge of a second monitor of a second computer connected to the second computer interface unit, where the second monitor is on the right side of the first monitor.

9. The KVM switch apparatus in claim 8, wherein the keyboard connection interface and the mouse connection interface are USB interfaces or PS/2 interfaces.

10. The KVM switch apparatus in claim 9, wherein the processor comprises circuit for PS/2 to USB interface conversion.
